(19) United States
(12) Patent Application Publication
(10) Pub. No.: US 2026/0287757 A1
(43) Pub. Date: Sep. 24, 2026

(54) Method for Determining Raw Observation Precision of Satellite-Borne GNSS Receiver

(71) Applicants: BEIJING RESEARCH INSTITUTE OF TELEMETRY, Beijing (CN); AEROSPACE LONG MARCH LAUNCH VEHICLE TECHNOLOGY CO., LTD, Beijing (CN)

(72) Inventors: Fengguo Zhang, Beijing (CN); Jinbang Zhang, Beijing (CN); Qianghua Yu, Beijing (CN); Pengfei Geng, Beijing (CN); Ruwei Zhang, Beijing (CN)

(21) Appl. No.: 19/478,085

(22) PCT Filed: Sep. 5, 2023
(86) PCT No.: PCT/CN2023/116958

§ 371 Date: Oct. 23, 2025

(30) Foreign Application Priority Data
Apr. 26, 2023 (CN) 202310464701.X

(51) Int. Cl. G01S 19/37; G01S 19/23

(52) U.S. Cl. CPC G01S 19/37; G01S 19/23

(57) ABSTRACT

A method for determining the raw observation precision of a satellite-borne GNSS receiver, comprising: S1: selecting a raw observation data file, and performing data preprocessing; selecting one channel as a reference channel and other K-1 channels as test channels; selecting a test channel, searching for a time intersection between the reference channel data and selected test channel data; selecting a data segment, obtaining inter-channel differences between the reference channel data and the test channel data in the selected data segment, and obtaining a triple difference array PrD3 of pseudorange observations and a triple difference array CpD3 of carrier phase observations; determining a pseudorange root mean square X_{RMS} and a pseudorange standard deviation X_{STD} for the selected data segment of the selected test channel based on PrD3, and determining a carrier phase root mean square X_{RMS2} and a carrier phase standard deviation X_{STD2} for the selected data segment of the selected test channel based on CpD3.

### CROSS-REFERENCE TO RELATED APPLICATIONS

This application is a U.S. national phase application of International Application No. PCT/CN2023/116958, filed on Sep. 5, 2023, which claims the priority of the Chinese patent application No. 202310464701.X and titled “method for determining a raw observation accuracy of a spaceborne global navigation satellite system (GNSS) receiver” filed with the China National Intellectual Property Administration on Apr. 26, 2023, the entire disclosure of which is incorporated herein by reference for all purposes.

### TECHNICAL FIELD

The present disclosure relates to the field of satellite navigation, and in particular a method for determining a raw observation accuracy of a spaceborne global navigation satellite system (GNSS) receiver.

### BACKGROUND

With the development of global navigation satellite system (GNSS), the spaceborne GNSS receiver has become an effective means for high-accuracy orbit determination of various satellites, providing all-day, all-weather, global, high-precision position, velocity, and time information for satellites. It is not only highly accurate but also features mature technology, low cost, and wide coverage, and is widely used. As the aerospace field demands increasingly higher accuracy for satellite orbit determination, post-processed precise orbit determination is required in addition to real-time orbit determination. Thus, it is essential to ensure that the raw observation accuracy (mainly pseudorange values and carrier phase values) output by the spaceborne GNSS receiver meets the specified standards via extensive simulation tests under various test scenarios.

### SUMMARY

A first technical solution of the disclosure provides a method for determining a raw observation accuracy of a spaceborne GNSS receiver, in which the spaceborne GNSS receiver includes Y satellite navigation systems, each satellite navigation system includes M frequency points, and each frequency point corresponds to K channels; where Y≥1, M≥1, K>1; one raw observation data file stores data of M*K channels corresponding to all frequency points of one satellite navigation system; and the method is applied in a static observation scenario and includes:
S1: selecting a raw observation data file, and obtaining, by performing data preprocessing, continuous observation data of pseudorange and continuous observation data of carrier phase in data of each channel corresponding to each frequency point, in which the continuous observation data of pseudorange is within a pseudorange threshold range, and the continuous observation data of carrier phase does not include consecutive zero values;
S2: selecting a frequency point, selecting, among the K channels corresponding to a selected frequency point, one channel as a reference channel and K-1 channels as test channels, filtering, based on a satellite orbit type, pseudorange data and carrier phase data of the reference channel from preprocessed data of the raw observation data file as reference channel data, and filtering, based on the satellite orbit type, pseudorange data and carrier phase data of the other K-1 channels from the preprocessed data of the raw observation data file as test channel data;
S3: selecting a test channel, searching for a time intersection between the reference channel data and selected test channel data, and filtering data segments that meet a time length threshold within the time intersection, obtaining a number of data segments, N, and a starting time and an ending time of each data segment;
S4: selecting a data segment, obtaining inter-channel differences between the reference channel data and the test channel data in a selected data segment, and obtaining, by performing a triple difference on the inter-channel differences, a triple difference array PrD3 of pseudorange observations and a triple difference array CpD3 of carrier phase observations;
S5: determining a pseudorange root mean square X_{RMS} value and a pseudorange standard deviation X_{STD} value for the selected data segment of a selected test channel based on the triple difference array PrD3 of pseudorange observations, and determining a carrier phase root mean square X_{RMS2} value and a carrier phase standard deviation X_{STD2} value for the selected data segment of the selected test channel based on the triple difference array CpD3 of carrier phase observations;
S6: repeating steps S4 to S5, obtaining a first set of pseudorange root mean square X_{RMS} values, pseudorange standard deviation X_{STD} values, carrier phase root mean square X_{RMS2} values, and carrier phase standard deviation X_{STD2} values of N data segments of the selected test channel, and outputting the first set of pseudorange root mean square X_{RMS} values, pseudorange standard deviation X_{STD} values, the carrier phase root mean square X_{RMS2} values, and carrier phase standard deviation X_{STD2} values graphically;
S7: repeating steps S3 to S6, obtaining a second set of pseudorange root mean square X_{RMS} values, pseudorange standard deviation X_{STD} values, carrier phase root mean square X_{RMS2} values, and carrier phase standard deviation X_{STD2} values of N data segments of all test channels corresponding to the selected frequency point;
S8: repeating steps S2 to S7, obtaining a third set of pseudorange root mean square X_{RMS} values, pseudorange standard deviation X_{STD} values, carrier phase root mean square X_{RMS2} values, and carrier phase standard deviation X_{STD2} values of N data segments of all test channels corresponding to all frequency points;
S9: repeating steps S1 to S8, obtaining a fourth set of pseudorange root mean square X_{RMS} values, pseudorange standard deviation X_{STD} values, carrier phase root mean square X_{RMS2} values, and carrier phase standard deviation X_{STD2} values of N data segments of all test channels corresponding to all frequency points in all raw observation data files, and outputting the fourth set of pseudorange root mean square X_{RMS} values, pseudorange standard deviation X_{STD} values, carrier phase root mean square X_{RMS2} values, and carrier phase standard deviation X_{STD2} values as the raw observation accuracy of the spaceborne GNSS receiver; and
adjusting a component of the spaceborne GNSS receiver based on the raw observation accuracy of the spaceborne GNSS receiver when the raw observation accuracy does not meet an accuracy requirement.

A second technical solution of the disclosure provides a method for determining a raw observation accuracy of a spaceborne GNSS receiver, and the method is used for determining a raw observation accuracy in a dynamic observation scenario and includes:
T1: selecting a raw observation data file, and obtaining, by performing data preprocessing, continuous observation data of pseudorange and continuous observation data of carrier phase without consecutive zero values within a threshold range corresponding to each frequency point of each satellite channel;
T2: selecting a frequency point, selecting one channel as a reference channel and other K-1 channels as test channels, filtering, based on a satellite orbit type, pseudorange data and carrier phase data of the reference channel from the preprocessed data of the raw observation data file as reference channel data, and filtering, based on the satellite orbit type, pseudorange data and carrier phase data of the other K-1 channels from the preprocessed data of the raw observation data file as test channel data;
T3: selecting a test channel, searching for a time intersection between the reference channel data and selected test channel data, and filtering data segments that meet a time length threshold within the time intersection, obtaining a number of data segments, N, and a starting time and an ending time of each data segment;
T4: selecting a data segment, obtaining inter-channel differences between the reference channel data and the test channel data in the selected data segment, and obtaining, by performing a quadruple difference on the inter-channel differences, a quadruple difference array PrD4 of pseudorange observations and a quadruple difference array CpD4 of carrier phase observations;
T5: determining a pseudorange root mean square X_{RMS} value and a pseudorange standard deviation X_{STD} value for the selected data segment of the selected test channel based on the quadruple difference array PrD4 of pseudorange observations, and determining a carrier phase root mean square X_{RMS2} value and a carrier phase standard deviation X_{STD2} value for the selected data segment of the selected test channel based on the quadruple difference array CpD4 of carrier phase observations;
T6: repeating steps T4 to T5, obtaining a first set of pseudorange root mean square X_{RMS} values, pseudorange standard deviation X_{STD} values, carrier phase root mean square X_{RMS2} values, and carrier phase standard deviation X_{STD2} values for N data segments of the selected test channel, and outputting the first set of pseudorange root mean square X_{RMS} values, pseudorange standard deviation X_{STD} values, carrier phase root mean square X_{RMS2} values, and carrier phase standard deviation X_{STD2} values graphically;
T7: repeating steps T3 to T6, obtaining a second set of pseudorange root mean square X_{RMS} values, pseudorange standard deviation X_{STD} values, carrier phase root mean square X_{RMS2} values, and carrier phase standard deviation X_{STD2} values for N data segments of all test channels corresponding to the selected frequency point;
T8: repeating steps T2 to T7, obtaining a third set of pseudorange root mean square X_{RMS} values, pseudorange standard deviation X_{STD} values, carrier phase root mean square X_{RMS2} values, and carrier phase standard deviation X_{STD2} values for N data segments of all test channels corresponding to all frequency points;
T9: repeating steps T1 to T8, obtaining a fourth set of pseudorange root mean square X_{RMS} values, pseudorange standard deviation X_{STD} values, carrier phase root mean square X_{RMS2} values, and carrier phase standard deviation X_{STD2} values for N data segments of all test channels corresponding to all frequency points in all raw observation data files, and outputting the fourth set of pseudorange root mean square X_{RMS} values, pseudorange standard deviation X_{STD} values, carrier phase root mean square X_{RMS2} values, and carrier phase standard deviation X_{STD2} values as the raw observation accuracy of the spaceborne GNSS receiver; and
adjusting a component of the spaceborne GNSS receiver based on the raw observation accuracy of the spaceborne GNSS receiver when the raw observation accuracy does not meet an accuracy requirement.

A third technical solution of the disclosure provides an electronic device. The electronic device includes a memory, configured to store computer-readable instructions; and a processor, configured to run the computer-readable instructions to execute the method according to the first technical solution.

### BRIEF DESCRIPTION OF THE DRAWINGS

FIG. 1 is a flowchart illustrating automatic evaluation of raw observation accuracy.

FIGS. 2A-2D are diagrams illustrating GPS L1 pseudorange evaluation results and carrier phase accuracy evaluation results for satellite 18.

FIGS. 3A-3D are diagrams illustrating GPS L2 pseudorange evaluation results and carrier phase accuracy evaluation results for satellite 18.

FIGS. 4A-4D are diagrams illustrating BDS B1 pseudorange evaluation results and carrier phase accuracy evaluation results for satellite 18.

### DETAILED DESCRIPTION

The disclosure will be further described in detail below with reference to the accompanying drawings and specific embodiments.

With the development of global navigation satellite system (GNSS), the spaceborne GNSS receiver has become an effective means for high-accuracy orbit determination of various satellites, providing all-day, all-weather, global, high-precision position, velocity, and time information for satellites. It is not only highly accurate but also features mature technology, low cost, and wide coverage, and is widely used. As the aerospace field demands increasingly higher accuracy for satellite orbit determination, post-processed precise orbit determination is required in addition to real-time orbit determination. Thus, it is essential to ensure that the raw observation accuracy (mainly pseudorange values and carrier phase values) output by the spaceborne GNSS receiver meets the specified standards via extensive simulation tests under various test scenarios.

Currently, the evaluation of real-time positioning/orbit determination accuracy of the spaceborne GNSS receivers primarily involves comparing positioning/orbit determination results output by the GNSS receiver with simulated position information from a simulator and obtaining differences, and determining a root mean square (RMS) value of the differences. Except for troubleshooting abnormal receiver operation, the raw observations are rarely evaluated directly. The evaluation of on-orbit accuracy of the spaceborne GNSS receivers is mainly performed by comparative analysis of post-processed precise orbit determination results and downlinked real-time orbit determination results, determining the RMS value of their differences. In the orbit determination accuracy evaluation method, the post-processed precise orbit determination serves as the reference for position and velocity. The accuracy of the raw observations is one of the most critical factors determining the accuracy of the post-processed precise orbit determination, directly influencing the precision of the post-processed precise orbit determination and indirectly affecting the accuracy and reliability of the on-orbit accuracy evaluation.

After the development of the spaceborne GNSS receiver is completed, the evaluation of raw observation accuracy is a key step. Currently, two common evaluation methods are mainly used: one is a zero-baseline measurement method using a reference receiver and a test receiver, and the other is a double difference measurement method using a receiver and a simulator. Both of the methods involve double difference processing. For a spaceborne receiver experiencing acceleration and jerk, the methods cannot meet accuracy evaluation requirements for carrier phase. Further, the methods require additional receivers, leading to high hardware costs and high test complexity. The specific implementation of the above two methods involves opening a data file, randomly selecting a segment of valid raw observation data (pseudorange values and carrier phase values) from a certain channel on a certain frequency point of the receiver, and then searching and selecting valid data from other channels within the same time period by manual interpretation. After obtaining inter-channel differences between the selected segment of valid raw observation data and the selected valid data, double difference processing is performed, followed by statistical analysis using a data processing tool.

The disclosure provides a method for determining a raw observation accuracy of a spaceborne global navigation satellite system (GNSS) receiver. The spaceborne GNSS receiver includes Y satellite navigation systems, each satellite navigation system includes M frequency points, and each frequency point corresponds to K channels; where Y≥1, M≥1, K>1; one raw observation data file stores data of M*K channels corresponding to all frequency points of one satellite navigation system.

The method of the disclosure implements an accuracy evaluation function for the raw observations of the spaceborne GNSS receiver via code. It achieves accuracy evaluation for pseudorange and carrier phase via inter-channel differences and triple differences or quadruple differences between different channels. The method possesses an automatic batch processing capability for raw observation data files. It may automatically traverse and match various satellite channels, and automatically judge and process all time segment data meeting predetermined conditions. A difference order may be set, and different difference orders may be selected for static and high dynamic test scenarios. It does not require an additional receiver serving as a test benchmark.

### Embodiment 1

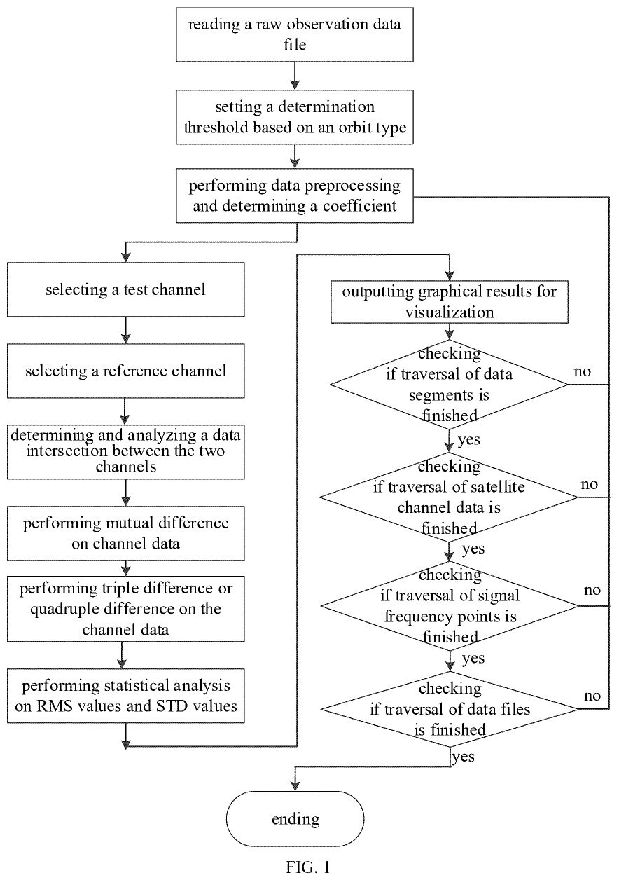

A flow of the method is shown in FIG. 1. For GNSS static observation data, the method is specifically implemented via the following steps.

At step 1: a raw observation data file is selected, continuous observation data of pseudorange and continuous observation data of carrier phase in data of each channel corresponding to each frequency point are obtained by performing data preprocessing, in which the continuous observation data of pseudorange is within pseudorange threshold range, and the continuous observation data of carrier phase does not include consecutive zero values.

At step 2: a frequency point is selected, one channel is selected as a reference channel and other K-1 channels as test channels, pseudorange data and carrier phase data of the reference channel are filtered from preprocessed data of the raw observation data file as reference channel data based on a satellite orbit type, and pseudorange data and carrier phase data of the other K-1 channels are filtered from the preprocessed data of the raw observation data file as test channel data based on the satellite orbit type; in which K is a total number of channels under the selected frequency point.

A selection rule for the reference channel in the disclosure is: sequentially pre-judging data validity of each channel, and there being valid data and a length of at least one segment of continuous data meeting the time length threshold (for a static test scenario, the time length threshold may be set to ThD1=1800s), in which the data validity includes: pseudorange observation data being within the pseudorange threshold range, and carrier phase observation data not including consecutive zero values.

Performing data preprocessing mainly involves filtering pseudorange values and carrier phase values in the raw observation data file, and selecting all continuous observation data meeting preset conditions of each frequency point of each satellite channel. During data preprocessing, a specified data length or a specified starting time and a specified ending time may be skipped. Based on orbit types, navigation satellites are classified into medium earth orbit (MEO) satellites, with an orbital altitude of 2×10⁴ km; geostationary earth orbit (GEO) satellites, with an orbital altitude of 3.6×10⁴ km; and geosynchronous orbit (IGSO) satellites, with an orbital altitude of 3.6×10⁴ km. A MEO pseudorange range is usually 2×10⁴~2.6×10⁴ km, and a GEO pseudorange range and an IGSO pseudorange range is usually 3.6×10⁴~4.15×10⁴ km. The pseudorange threshold may be set to ThPr=[1.8×10⁴~4.2×10⁴ km], and pseudorange observation data within the pseudorange threshold range is obtained by filtering. Carrier phase values may be positive or negative, and zero values may occur, but valid data does not include multiple consecutive zero values, thus data segments where the carrier phase values include multiple consecutive zero values are filtered out.

To eliminate influence of channel noise, inter-channel difference between the test channel data and the reference channel data are obtained, but time consistency between the two must be ensured, meaning the data must be from the same time instance. The pseudorange threshold for the reference channel data is set to ThPr=[1.8×10⁴~4.2×10⁴ km].

At step 3: a test channel is selected, a time intersection between the reference channel data and selected test channel data is searched for, and data segments that meet a time length threshold within the time intersection are filtered, a number of data segments, N, and a starting time and an ending time of each data segment are obtained.

For observation data of a certain frequency point, traversing from a first test channel, a time intersection between all subsequent test channels and the reference channel is searched for and all data segments meeting the time length threshold are obtained. A number of data segments is recorded as N, and a starting sequence number and an ending sequence number of each data segment are recorded as [Tsi, Tei], where I=1~N. The time length threshold for data is usually set based on different test scenarios; for static tests, ThD1=1800s.

At step 4: a data segment is selected, inter-channel differences between the reference channel data and the test channel data in the data segment are obtained, and a triple difference array PrD3 of pseudorange observations and a triple difference array CpD3 of carrier phase observations are obtained by performing a triple difference on the inter-channel differences. The step 4 includes the following steps:

step 41: obtaining the inter-channel differences between the reference channel data and the test channel data in the data segment:

$$△ {Pr}_{i} = {Pr}_{ij} - {Pr}_{ik}$$

$$△ {Cp}_{i} = {Cp}_{ij} - {Cp}_{ik}$$

where ΔPrᵢ represents an inter-channel difference array of pseudorange observations obtained in an i-th data segment, ΔCpᵢ represents an inter-channel difference array of carrier phase observations obtained in the i-th data segment, i is a data segment serial number, with a value range from 1 to N; Prᵢⱼ represents an array composed of all pseudorange observations of the reference channel in the i-th data segment, Prᵢₖ represents an array composed of all pseudorange observations of a k-th test channel in the i-th data segment; Cpᵢⱼ represents an array composed of all carrier phase observations of the reference channel in the i-th data segment, Cpᵢₖ represents an array composed of all carrier phase observations of the k-th test channel in the i-th data segment; where k=1, 2, . . . , K, and k≠j; and
step 42: performing a triple difference on the inter-channel difference array ΔPrᵢ of pseudorange observations and the inter-channel difference array ΔCpᵢ of carrier phase observations respectively to eliminate influence of acceleration;
in which a single difference PrD1(n₁), a double difference PrD2(n₂), and a triple difference PrD3(n₃) of pseudorange observations are expressed as:

$$PrD 1 ( {n}_{1} ) = △ Pri ( {n}_{1} + 1 ) - △ Pri ( {n}_{1} ) ;$$

$$PrD 2 ( {n}_{2} ) = PrD 1 ( {n}_{2} + 1 ) - PrD 1 ( {n}_{2} ) ;$$

$$PrD 3 ( {n}_{3} ) = PrD 2 ( {n}_{3} + 1 ) - PrD 2 ( {n}_{3} ) ;$$

where n₁ is a serial number and ranges from 1 to D₁-1, and D₁ is a number of pseudorange observations included in the data segment; PrD1(1) to PrD1(D₁-1) form a single difference array PrD1 of pseudorange observations;
n₂ is a serial number and ranges from 1 to D₁-2, and PrD2(1) to PrD2(D₁-2) form a double difference array PrD2 of pseudorange observations; and
n₃ is a serial number and ranges from 1 to D₁-3, and PrD3(1) to PrD3(D₁-3) form a triple difference array PrD3 of pseudorange observations;
a single difference CpD1(n₅), a double difference CpD2(n₆), and a triple difference CpD3(n₇) of carrier phase observations are expressed as:

$$CpD 1 ( {n}_{5} ) = △ Cpi ( {n}_{5} + 1 ) - △ Cpi ( {n}_{5} ) ;$$

$$CpD 2 ( {n}_{6} ) = CpD 1 ( {n}_{6} + 1 ) - CpD 1 ( {n}_{6} ) ;$$

$$CpD 3 ( {n}_{7} ) = CpD 2 ( {n}_{7} + 1 ) - CpD 2 ( {n}_{7} ) ;$$

where n₅ is a serial number and ranges from 1 to D₂-1, and D₂ is a number of carrier phase observations included in the data segment; CpD1(1) to CpD1(D₂-1) form a single difference array CpD1 of carrier phase observations;
n₆ is a serial number and ranges from 1 to D₂-2, and CpD2(1) to CpD2(D₂-2) form a double difference array CpD2 of carrier phase observations; and
n₇ is a serial number and ranges from 1 to D₂-3, and CpD3(1) to CpD3(D₂-3) form a triple difference array CpD3 of carrier phase observations.

At step 5: a pseudorange root mean square X_{RMS} value and a pseudorange standard deviation X_{STD} value for the selected data segment of the selected test channel are determined based on the triple difference array PrD3 of pseudorange observations, and a carrier phase root mean square X_{RMS2} value and a carrier phase standard deviation X_{STD2} value for the selected data segment of the selected test channel are determined based on the triple difference array CpD3 of carrier phase observations.

The pseudorange root mean square X_{RMS} value and the pseudorange standard deviation X_{STD} value are as follows:

$${X}_{RMS} = \frac{1}{A} \cdot \sqrt{\frac{1}{{D}_{1} - 3} ( {{\sum }_{{n}_{3} = 1}}^{{D}_{1} - 3} {\vert PrD 3 ( {n}_{3} ) \vert}^{2} )} ,$$

where A is a noise coefficient for triple difference of observations, and a value of A is \sqrt{40};

$${X}_{STD} = \frac{1}{A} \cdot \sqrt{\frac{1}{{D}_{1} - 4} ( {{\sum }_{{n}_{3} = 1}}^{{D}_{1} - 3} {\vert PrD 3 ( {n}_{3} ) - \overline{{X}_{1}} \vert}^{2} )} ,$$

$$where {\overline{X}}_{1} = \frac{1}{{D}_{1} - 3} {{\sum }_{{n}_{3} = 1}}^{{D}_{1} - 3} PrD 3 ( {n}_{3} ) .$$

The carrier phase root mean square X_{RMS2} value and the carrier phase standard deviation X_{STD2} value are as follows:

$${X}_{RMS 2} = \frac{1}{A} \cdot \sqrt{\frac{1}{{D}_{1} - 3} ( {{\sum }_{{n}_{3} = 1}}^{{D}_{1} - 3} {\vert CpD 3 ( {n}_{3} ) \vert}^{2} )} ,$$

$${X}_{STD 2} = \frac{1}{A} \cdot \sqrt{\frac{1}{{D}_{1} - 4} ( {{\sum }_{{n}_{3} = 1}}^{{D}_{1} - 3} {\vert CpD 3 ( {n}_{3} ) - \overline{{X}_{2}} \vert}^{2} )} ,$$

$$where {\overline{X}}_{2} = \frac{1}{{D}_{1} - 3} {{\sum }_{{n}_{3} = 1}}^{{D}_{1} - 3} CpD 3 ( {n}_{3} ) .$$

A method for determining the noise coefficient A for triple difference of observations provided in the embodiments is as follows.

Assuming an observation value sequence of the data segment is: [a0 a1 a2 a3 a4 a5 a6 a7 a8 a9 a10 . . . ], then an observation value sequence obtained by performing pseudorange and carrier phase triple difference is: [a3−3a2+3a1−a0 a4−3a3+3a2−a1 a5−3a4+3a3−a2 . . . ].

Thus, it can be seen that coefficients of each polynomial in the observation value sequence obtained by performing triple difference are, in order, 1, −3, 3, −1. The noise coefficient for triple difference of observations is A=\sqrt{[1²+(−3)²+3²+(−1)²]×2}=\sqrt{40}.

At step 6: steps S4 to S5 are repeated, a first set of pseudorange root mean square X_{RMS} values, pseudorange standard deviation X_{STD} values, the carrier phase root mean square X_{RMS2} values, and carrier phase standard deviation X_{STD2} values for N data segments of the selected test channel is obtained, and the first set of pseudorange root mean square X_{RMS} values, pseudorange standard deviation X_{STD} values, carrier phase root mean square X_{RMS2} values, and carrier phase standard deviation X_{STD2} values is outputted graphically.

At step 7: steps S3 to S6 are repeated, a second set of pseudorange root mean square X_{RMS} values, pseudorange standard deviation X_{STD} values, carrier phase root mean square X_{RMS2} values, and carrier phase standard deviation X_{STD2} values for N data segments of all test channels corresponding to the selected frequency point is obtained.

At step 8: steps S2 to S7 are repeated, a third set of pseudorange root mean square X_{RMS} values, pseudorange standard deviation X_{STD} values, carrier phase root mean square X_{RMS2} values, and carrier phase standard deviation X_{STD2} values for N data segments of all test channels corresponding to all frequency points is obtained.

At step 9: steps S1 to S8 are repeated, a fourth set of pseudorange root mean square X_{RMS} values, pseudorange standard deviation X_{STD} values, carrier phase root mean square X_{RMS2} values, and carrier phase standard deviation X_{STD2} values for N data segments of all test channels corresponding to all frequency points in all raw observation data files is obtained, and the fourth set of pseudorange root mean square X_{RMS} values, pseudorange standard deviation X_{STD} values, carrier phase root mean square X_{RMS2} values, and carrier phase standard deviation X_{STD2} values is outputted as the raw observation accuracy of the spaceborne GNSS receiver.

The method further includes: adjusting a component of the spaceborne GNSS receiver based on the raw observation accuracy of the spaceborne GNSS receiver when the raw observation accuracy does not meet an accuracy requirement.

In an embodiment of the disclosure, adjusting the component of the spaceborne GNSS receiver includes at least one of: adjusting an antenna layout, replacing a radio frequency (RF) chip, or replacing a digital signal processing baseband chip.

The disclosure further provides a computer-readable storage medium. The computer-readable storage medium stores a computer program that, when executed by a processor, implements steps of the method described above.

The disclosure further provides an electronic device. The electronic device includes a memory, a processor, and a computer program stored in the memory and executable on the processor. When the processor executes the computer program, steps of the method described above are implemented.

### Embodiment 2

For GNSS dynamic observation data, the method is specifically implemented by the following steps.

At step 1: a raw observation data file is selected, continuous observation data of pseudorange and continuous observation data of carrier phase in data of each satellite channel corresponding to each frequency point are obtained by performing data preprocessing and filtering pseudorange values and carrier phase values in the raw observation data file, in which the continuous observation data of pseudorange is within a pseudorange threshold range, and the continuous observation data of carrier phase does not include consecutive zero values.

At step 2: a frequency point is selected, one channel is selected as a reference channel and other K-1 channels as test channels, pseudorange data and carrier phase data of the reference channel are filtered from the preprocessed data of the raw observation data file as reference channel data based on a satellite orbit type, and pseudorange data and carrier phase data of the other K-1 channels are filtered from the preprocessed data of the raw observation data file as test channel data based on the satellite orbit type; in which K is a total number of channels under the selected frequency point.

A selection rule for the reference channel is: sequentially pre-judging data validity of each channel, and there being valid data and a length of at least one segment of continuous data meeting a time length threshold (for a dynamic test scenario, the time length threshold may be set to ThD1=1800s).

Performing data preprocessing mainly involves filtering pseudorange values and carrier phase values in the raw observation data file, and selecting all continuous observation data meeting a preset condition of each frequency point of each satellite channel. During the data preprocessing, a specified data length or a specified starting time and a specified ending time may be skipped. Based on orbit types, navigation satellites are classified into MEO satellites, with an orbital altitude of 2×10⁴ km; GEO satellites, with an orbital altitude of 3.6×10⁴ km; and IGSO satellites, with an orbital altitude of 3.6×10⁴ km. A MEO pseudorange range is usually 2×10⁴~2.6×10⁴ km, and a GEO pseudorange range and an IGSO pseudorange range is usually 3.6×10⁴~4.15×10⁴ km. The pseudorange threshold may be set to ThPr=[1.8×10⁴~4.2×10⁴ km], and pseudorange observation data within the pseudorange threshold range is obtained by filtering. Carrier phase values may be positive or negative, and zero values may occur, but valid data does not include multiple consecutive zero values, thus data segments where the carrier phase values include multiple consecutive zero values are filtered out.

To eliminate the influence of channel noise, inter-channel differences between the test channel data and the reference channel data are obtained, but time consistency between the two must be ensured, meaning the test channel data and the reference channel data must correspond the same time instance. The pseudorange threshold for the reference channel data is set to ThPr=[1.8×10⁴~4.2×10⁴ km].

At step 3: a test channel is selected, a time intersection between the reference channel data and selected test channel data is searched for, and data segments that meet a time length threshold within the time intersection are filtered, a number of data segments, N, and a starting time and an ending time of each data segment are obtained.

For observation data of a certain frequency point, traversing from a first test channel, a time intersection between all subsequent test channels and the reference channel is searched for and all data segments meeting the time length threshold are obtained. A number of data segments is recorded as N, and a starting sequence number and an ending sequence number of each data segment are recorded as [Tsi, Tei], where i=1~N. The time length threshold for data is usually set based on different test scenarios; for a low-orbit dynamic scenario, ThD1=300s.

At step 4: a data segment is selected, inter-channel differences between the reference channel data and the test channel data in the selected data segment are obtained, and a quadruple difference array PrD4 of pseudorange observations and a quadruple difference array CpD4 of carrier phase observations are obtained by performing a quadruple difference on the inter-channel differences. The step 4 includes the following steps:
step 41: obtaining the inter-channel differences between the reference channel data and the test channel data in the data segment:

$$△ {Pr}_{i} = {Pr}_{ij} - {Pr}_{ik}$$

$$△ {Cp}_{i} = {Cp}_{ij} - {Cp}_{ik}$$

where ΔPrᵢ represents an inter-channel difference array of pseudorange observations obtained in an i-th data segment, ΔCpᵢ represents an inter-channel difference array of carrier phase observations obtained in the i-th data segment, i is a data segment serial number, with a value range from 1 to N; j represents the reference channel, and k represents the test channel, where k=1, 2, . . . , K, and k≠j; Prᵢⱼ represents an array composed of all pseudorange observations of the reference channel in the i-th data segment, Prᵢₖ represents an array composed of all pseudorange observations of a k-th test channel in the i-th data segment; Cpᵢⱼ represents an array composed of all carrier phase observations of the reference channel in the i-th data segment, Cpᵢₖ represents an array composed of all carrier phase observations of the k-th test channel in the i-th data segment; and
step 42: performing a quadruple difference on the inter-channel difference array ΔPrᵢ of pseudorange observations and the inter-channel difference array ΔCpᵢ of carrier phase observations respectively to eliminate influence of jerk.

A single difference PrD1(n₁), a double difference PrD2(n₂), a triple difference PrD3(n₃), and a quadruple difference PrD4(n₄) of pseudorange observations are expressed as:

$$PrD 1 ( {n}_{1} ) = △ Pri ( {n}_{1} + 1 ) - △ Pri ( {n}_{1} ) ;$$

$$PrD 2 ( {n}_{2} ) = PrD 1 ( {n}_{2} + 1 ) - PrD 1 ( {n}_{2} ) ;$$

$$PrD 3 ( {n}_{3} ) = PrD 2 ( {n}_{3} + 1 ) - PrD 2 ( {n}_{3} ) ;$$

$$PrD 4 ( {n}_{4} ) = PrD 3 ( {n}_{4} + 1 ) - PrD 3 ( {n}_{4} ) ;$$

where n₁ is a serial number and ranges from 1 to D₁-1, and D₁ is a number of pseudorange observations included in the data segment; PrD1(1) to PrD1(D₁-1) form a single difference array PrD1 of pseudorange observations;
n₂ is a serial number and ranges from 1 to D₁-2, and PrD2(1) to PrD2(D₁-2) form a double difference array PrD2 of pseudorange observations;
n₃ is a serial number and ranges from 1 to D₁-3, and PrD3(1) to PrD3(D₁-3) form a triple difference array PrD3 of pseudorange observations; and
n₄ is a serial number and ranges from 1 to D₁-4, and PrD4(1) to PrD4(D₁-4) form a quadruple difference array PrD4 of pseudorange observations.

A single difference CpD1(n₅), a double difference CpD2(n₆), a triple difference CpD3(n₇), and a quadruple difference CpD4(n₈) of carrier phase observations are expressed as:

$$CpD 1 ( {n}_{5} ) = △ Cpi ( {n}_{5} + 1 ) - △ Cpi ( {n}_{5} ) ;$$

$$CpD 2 ( {n}_{6} ) = CpD 1 ( {n}_{6} + 1 ) - CpD 1 ( {n}_{6} ) ;$$

$$CpD 3 ( {n}_{7} ) = CpD 2 ( {n}_{7} + 1 ) - CpD 2 ( {n}_{7} ) ;$$

$$CpD 4 ( {n}_{8} ) = CpD 3 ( {n}_{8} + 1 ) - CpD 3 ( {n}_{8} ) ;$$

where n₅ is a serial number and ranges from 1 to D₂-1, and D₂ is a number of carrier phase observations included in the data segment; CpD1(1) to CpD1(D₂-1) form a single difference array CpD1 of carrier phase observations;
n₆ is a serial number and ranges from 1 to D₂-2, and CpD2(1) to CpD2(D₂-2) form a double difference array CpD2 of carrier phase observations;
n₇ is a serial number and ranges from 1 to D₂-3, and CpD3(1) to CpD3 (D₂-3) form a triple difference array CpD3 of carrier phase observations; and
n₈ is a serial number and ranges from 1 to D₂-4, and CpD4(1) to CpD4 (D₂-4) form a quadruple difference array CpD4 of carrier phase observations.

At step 5: a pseudorange root mean square X_{RMS} and a pseudorange standard deviation X_{STD} of the selected data segment of the selected test channel are determined based on the quadruple difference array PrD4 of pseudorange observations, and a carrier phase root mean square X_{RMS2} and a carrier phase standard deviation X_{STD2} of the selected data segment of the selected test channel are determined based on the quadruple difference array CpD4 of carrier phase observations.

The pseudorange root mean square X_{RMS} and the pseudorange standard deviation X_{STD} are as follows:

$${X}_{RMS} = \frac{1}{B} \cdot \sqrt{\frac{1}{{D}_{1} - 4} ( {{\sum }_{{n}_{3} = 1}}^{{D}_{1} - 4} {\vert PrD 4 ( {n}_{4} ) \vert}^{2} )}$$

where B is a noise coefficient for quadruple difference of observations, and a value of B is \sqrt{140};

$${X}_{STD} = \frac{1}{B} \cdot \sqrt{\frac{1}{{D}_{1} - 5} ( {{\sum }_{n 4 = 1}}^{{D}_{1} - 4} {\vert PrD 4 ( {n}_{4} ) - \overline{{X}_{3}} \vert}^{2} )} ,$$

$$where \overline{{X}_{3}} = \frac{1}{{D}_{1} - 4} {{\sum }_{{n}_{4} = 1}}^{{D}_{1} - 4} PrD 4 ( {n}_{4} ) .$$

The carrier phase root mean square X_{RMS2} and the carrier phase standard deviation X_{STD2} in T4 are determined as follows:

$${X}_{RMS 2} = \frac{1}{B} \cdot \sqrt{\frac{1}{{D}_{1} - 4} ( {{\sum }_{{n}_{3} = 1}}^{{D}_{1} - 4} {\vert CpD 4 ( {n}_{4} ) \vert}^{2} )} ,$$

$${X}_{STD 2} = \frac{1}{B} \cdot \sqrt{\frac{1}{{D}_{1} - 5} ( {{\sum }_{n 4 = 1}}^{{D}_{1} - 4} {\vert CpD 4 ( {n}_{4} ) - \overline{{X}_{4}} \vert}^{2} )} ,$$

$$where \overline{{X}_{4}} = \frac{1}{{D}_{1} - 4} {{\sum }_{{n}_{4} = 1}}^{{D}_{1} - 4} CpD 4 ( {n}_{4} ) .$$

A method for determining the noise coefficient B for quadruple difference of observations provided in the embodiments is as follows.

Assuming an observation value sequence of the data segment is: [a0 a1 a2 a3 a4 a5 a6 a7 a8 a9 a10 . . . ], then an observation value sequence obtained by performing pseudorange and carrier phase quadruple difference is: [a₄−4a₃+6a₂−4a₁+a₀a5−4a₄+6a₃−4a₂+a₁ . . . ]. Thus, it can be seen that coefficients of each polynomial in the observation value sequence obtained by performing quadruple difference are, in order, 1, −4, 6, −4, 1. The noise coefficient for quadruple difference of observations is B=\sqrt{[1²+(−4)²+6²+(−4)²+1²]×2}=\sqrt{140}.

At step 6: steps 4 to 5 are repeated, a first set of pseudorange root mean square X_{RMS} values, pseudorange standard deviation X_{STD} values, carrier phase root mean square X_{RMS2} values, and carrier phase standard deviation X_{STD2} values for N data segments of the selected test channel is obtained, and the first set of pseudorange root mean square X_{RMS} values, pseudorange standard deviation X_{STD} values, carrier phase root mean square X_{RMS2} values, and carrier phase standard deviation X_{STD2} values is outputted graphically.

At step 7: steps 3 to 6 are repeated, a second set of pseudorange root mean square X_{RMS} values, pseudorange standard deviation X_{STD} values, carrier phase root mean square X_{RMS2} values, and carrier phase standard deviation X_{STD2} values of N data segments of all test channels corresponding to the selected frequency point is obtained.

At step 8: steps 2 to 7 are repeated, a third set of pseudorange root mean square X_{RMS} values, pseudorange standard deviation X_{STD} values, carrier phase root mean square X_{RMS2} values, and carrier phase standard deviation X_{STD2} values of N data segments of all test channels corresponding to all frequency points is obtained.

At step 9: steps 1 to 8 are repeated, a fourth set of pseudorange root mean square X_{RMS} values, pseudorange standard deviation X_{STD} values, carrier phase root mean square X_{RMS2} values, and carrier phase standard deviation X_{STD2} values of N data segments of all test channels corresponding to all frequency points in all raw observation data files is obtained, and the fourth set of pseudorange root mean square X_{RMS} values, pseudorange standard deviation X_{STD} values, carrier phase root mean square X_{RMS2} values, and carrier phase standard deviation X_{STD2} values is outputted as the raw observation accuracy of the spaceborne GNSS receiver.

The method further includes: adjusting a component of the spaceborne GNSS receiver based on the raw observation accuracy of the spaceborne GNSS receiver when the raw observation accuracy does not meet an accuracy requirement.

In an embodiment of the disclosure, adjusting the component of the spaceborne GNSS receiver includes at least one of: adjusting an antenna layout, replacing a radio frequency (RF) chip, or replacing a digital signal processing baseband chip.

The disclosure further provides a computer-readable storage medium. The computer-readable storage medium stores a computer program that, when executed by a processor, implements steps of the method described above.

The disclosure further provides an electronic device. The electronic device includes a memory, a processor, and a computer program stored in the memory and executable on the processor. When the processor executes the computer program, steps of the method described above are implemented.

The raw observation accuracy is one of the most critical factors determining the accuracy of post-processed precise orbit determination. The raw observation accuracy directly determines the accuracy of the post-processed precise orbit determination and indirectly determines the accuracy and reliability of the on-orbit accuracy evaluation. The method for determining the raw observation accuracy of the spaceborne GNSS receiver of the disclosure provides a reliable basis and guidance for judging the accuracy of post-processed precise orbit determination and for the on-orbit accuracy evaluation.

The method of the disclosure achieves accuracy evaluation for pseudorange and carrier phase via inter-channel differences and triple differences or quadruple differences between channels. The method may automatically traverse and match various satellite channels, and automatically judge and process all data segment meeting a predetermined condition. By setting the difference order, the method may determine the raw observation accuracy of the spaceborne GNSS receiver for the static test scenarios and the high dynamic test scenarios respectively.

The disclosure is further described below with specific numerical values. Taking a global positioning system (GPS) system and a Beidou navigation satellite system (BDS) system as an example, assuming a spaceborne GNSS receiver is in dynamic mode, a GNSS signal simulator is set to dual-system dual-frequency point mode (GPS L1, L2 and BDS B1I, B3I), an orbital altitude of a user receiver is set to 600 km, radio frequency signal is inputted into the GNSS receiver, and raw observation data output by the receiver is saved. The method provided in the disclosure is used for evaluating the raw observation data (pseudorange values and carrier phase values) accuracy. The specific steps are as follows.
At step 1: a data file is selected and code is ran;
At step 2: the code completes data preprocessing, filters test channel data and reference channel data, performs inter-channel difference, triple difference, and quadruple difference operations, determines the RMS and standard deviation, outputs results graphically, and traverses all channel data.
At step 3: evaluation results are checked, in which the pseudorange accuracy evaluation result and carrier phase accuracy evaluation result are saved as text and images, which may be viewed in a corresponding folder.

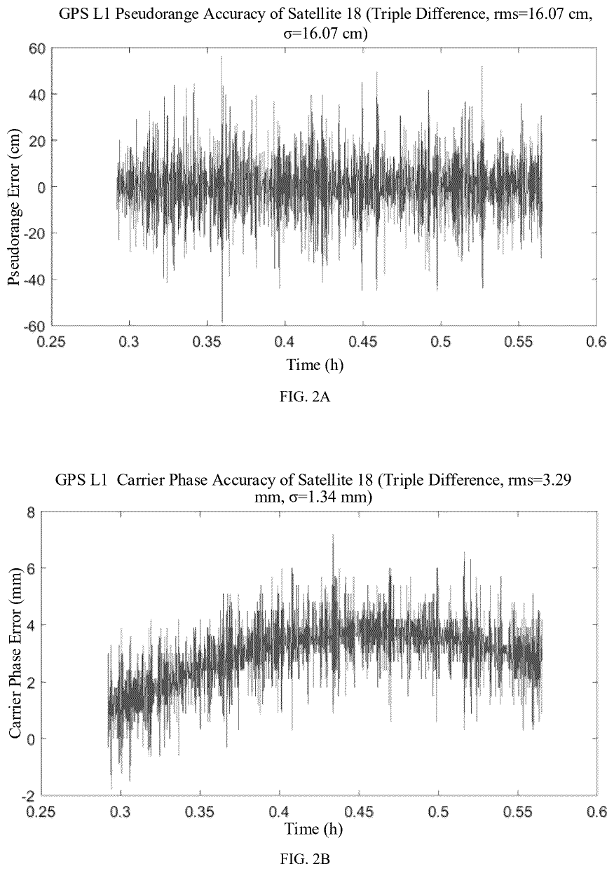

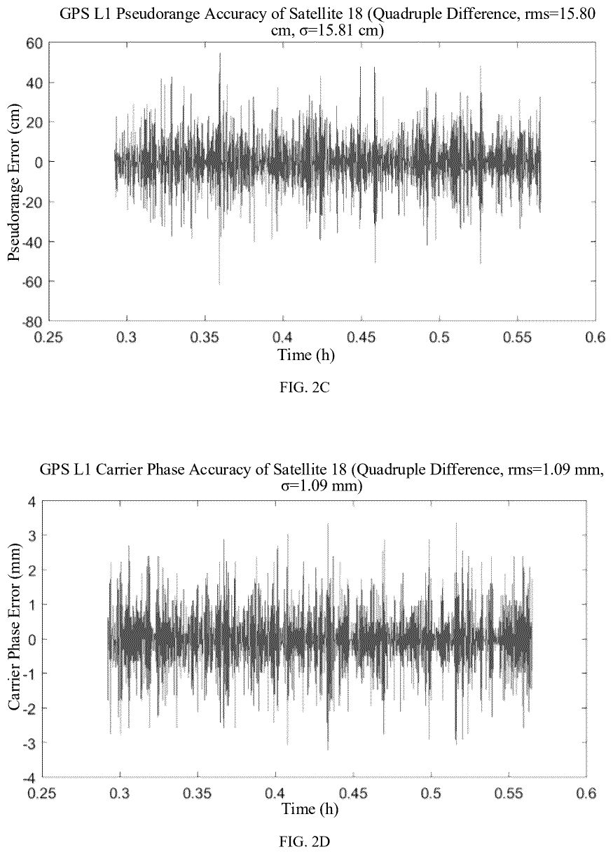

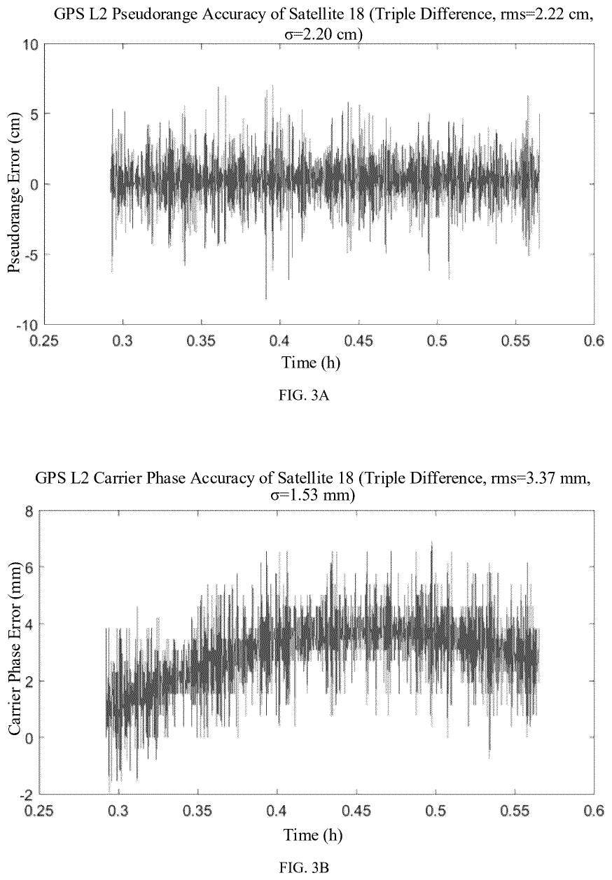

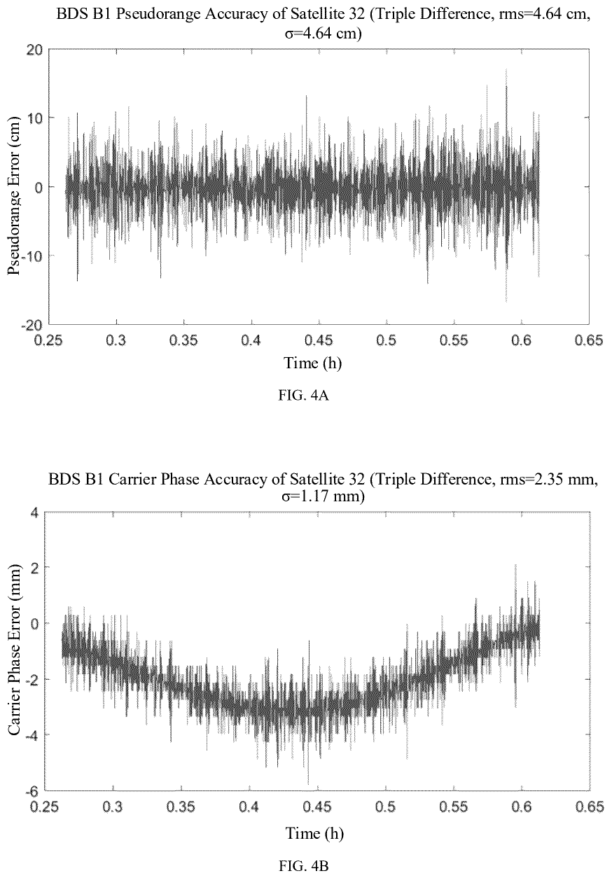

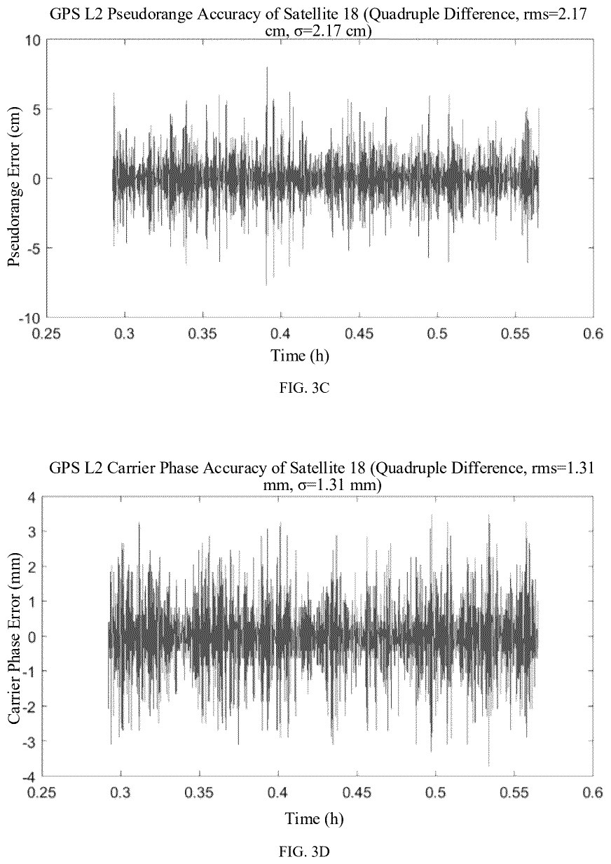

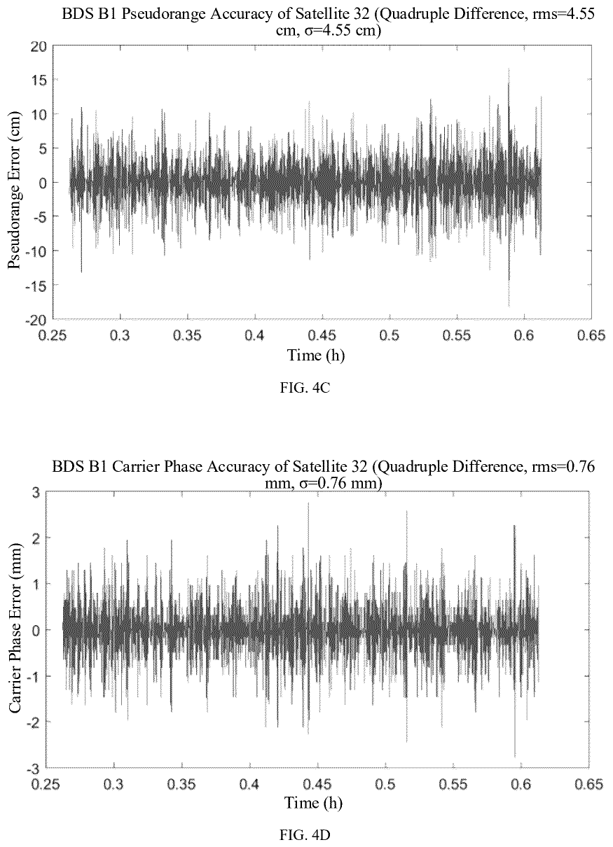

As shown in FIGS. 2A-2D, FIGS. 3A-3D, and FIGS. 4A-4D, an L1 pseudorange accuracy of GPS satellite 18 is about 15 cm and an L1 carrier phase accuracy of GPS satellite 18 is about 1 mm. An L2 pseudorange accuracy of GPS satellite 18 is about 2.2 cm and an L2 carrier phase accuracy of GPS satellite 18 is about 1.3 mm. A B1 pseudorange accuracy of BDS satellite 32 is about 4.5 cm and a B1 carrier phase accuracy of BDS satellite 32 is about 0.76 mm (the above values are all root mean square X_{RMS} values).

Although the disclosure is disclosed above with preferred embodiments, it is not intended to limit the disclosure. Any skilled in the art may make possible variations and modifications to the technical solution of the disclosure using the methods and technical content disclosed above without departing from the spirit and scope of the disclosure. Thus, any simple modification, equivalent variations, and modification made to the above embodiments based on the technical essence of the disclosure without departing from the content of the technical solution of the disclosure is within the protection scope of the technical solution of the disclosure.

1. A method for determining a raw observation accuracy of a spaceborne global navigation satellite system (GNSS) receiver, wherein the spaceborne GNSS receiver comprises Y satellite navigation systems, each satellite navigation system comprises M frequency points, and each frequency point corresponds to K channels; where Y≥1, M≥1, K>1; one raw observation data file stores data of M*K channels corresponding to all frequency points of one satellite navigation system; and the method is applied in a static observation scenario and comprises:
S1: selecting a raw observation data file, and obtaining, by performing data preprocessing, continuous observation data of pseudorange and continuous observation data of carrier phase in data of each channel corresponding to each frequency point, wherein the continuous observation data of pseudorange is within a pseudorange threshold range, and the continuous observation data of carrier phase does not comprise consecutive zero values;
S2: selecting a frequency point, selecting, among the K channels corresponding to a selected frequency point, one channel as a reference channel and K-1 channels as test channels, filtering, based on a satellite orbit type, pseudorange data and carrier phase data of the reference channel from preprocessed data of the raw observation data file as reference channel data, and filtering, based on the satellite orbit type, pseudorange data and carrier phase data of the K-1 channels from the preprocessed data of the raw observation data file as test channel data;
S3: selecting a test channel, searching for a time intersection between the reference channel data and selected test channel data, and filtering data segments that meet a time length threshold within the time intersection, obtaining a number of data segments, N, and a starting time and an ending time of each data segment;
S4: selecting a data segment, obtaining inter-channel differences between the reference channel data and the test channel data in a selected data segment, and obtaining, by performing a triple difference on the inter-channel differences, a triple difference array PrD3 of pseudorange observations and a triple difference array CpD3 of carrier phase observations;
S5: determining a pseudorange root mean square X_{RMS} value and a pseudorange standard deviation X_{STD} value for the selected data segment of a selected test channel based on the triple difference array PrD3 of pseudorange observations, and determining a carrier phase root mean square X_{RMS2} value and a carrier phase standard deviation X_{STD} value for the selected data segment of the selected test channel based on the triple difference array CpD3 of carrier phase observations;
S6: repeating steps S4 to S5, obtaining a first set of pseudorange root mean square X_{RMS} values, pseudorange standard deviation X_{STD} values, carrier phase root mean square X_{RMS2} values, and carrier phase standard deviation X_{STD} values for N data segments of the selected test channel, and outputting the first set of pseudorange root mean square X_{RMS} values, pseudorange standard deviation X_{STD} values, the carrier phase root mean square X_{RMS2} values, and the carrier phase standard deviation X_{STD} values graphically;
S7: repeating steps S3 to S6, obtaining a second set of pseudorange root mean square X_{RMS} values, pseudorange standard deviation X_{STD} values, carrier phase root mean square X_{RMS2} values, and carrier phase standard deviation X_{STD} values for N data segments of all test channels corresponding to the selected frequency point;
S8: repeating steps S2 to S7, obtaining a third set of pseudorange root mean square X_{RMS} values, pseudorange standard deviation X_{STD} values, carrier phase root mean square X_{RMS2} values, and carrier phase standard deviation X_{STD} values of N data segments of all test channels corresponding to all frequency points;
S9: repeating steps S1 to S8, obtaining a fourth set of pseudorange root mean square values, pseudorange standard deviation X_{STD} values, carrier phase root mean square X_{RMS2} values, and carrier phase standard deviation X_{STD} values of N data segments of all test channels corresponding to all frequency points in all raw observation data files, and outputting the fourth set of pseudorange root mean square X_{RMS} values, pseudorange standard deviation X_{STD} values, the carrier phase root mean square X_{RMS2} values, and carrier phase standard deviation X_{STD} values as the raw observation accuracy of the spaceborne GNSS receiver; and
adjusting a component of the spaceborne GNSS receiver based on the raw observation accuracy of the spaceborne GNSS receiver when the raw observation accuracy does not meet an accuracy requirement.

2. The method according to claim 1, wherein performing the data preprocessing in S1 comprises: removing data segments with a specified data length from the raw observation data file, and filtering pseudorange values and carrier phase values in the raw observation data file based on a filtering rule, wherein the filtering rule comprises: setting the pseudorange threshold range based on different orbital altitudes of different navigation satellites, and obtaining pseudorange observation data within the pseudorange threshold range by filtering; and filtering out a data segment where the carrier phase values comprise consecutive zero values in the raw observation data file.

3. The method according to claim 1, wherein a selection rule for the reference channel in S2 comprises: sequentially pre-judging data validity of each channel, and there being valid data and a length of at least one segment of continuous data meeting the time length threshold, wherein the data validity comprises: pseudorange observation data being within the pseudorange threshold range, and carrier phase observation data not comprising consecutive zero values.

4. The method according to claim 1, wherein obtaining the triple difference array PrD3 of pseudorange observations and the triple difference array CpD3 of carrier phase observations in S4 comprises:
step 41: obtaining the inter-channel differences between the reference channel data and the test channel data in the data segment:
$$△ {Pr}_{i} = {Pr}_{ij} - {Pr}_{ik}$$
$$△ {Cp}_{i} = {Cp}_{ij} - {Cp}_{ik}$$
where ΔPrᵢ represents an inter-channel difference array of pseudorange observations obtained in an i-th data segment, ΔCpᵢ represents an inter-channel difference array of carrier phase observations obtained in the i-th data segment, i is a data segment serial number, with a value range from 1 to N; Prᵢⱼ represents an array composed of all pseudorange observations of the reference channel in the i-th data segment, Prᵢₖ represents an array composed of all pseudorange observations of a k-th test channel in the i-th data segment; Cpᵢⱼ represents an array composed of all carrier phase observations of the reference channel in the i-th data segment, Cpᵢₖ represents an array composed of all carrier phase observations of the k-th test channel in the i-th data segment; where k=1, 2, . . . , K, and k≠j; and
step 42: performing a triple difference on the inter-channel difference array ΔPrᵢ of pseudorange observations and the inter-channel difference array ΔCpᵢ of carrier phase observations respectively;
wherein a single difference PrD1 (n₁), a double difference PrD2 (n₂), and a triple difference PrD3 (n₃) of pseudorange observations are expressed as:
$$PrD 1 ( {n}_{1} ) = △ Pri ( {n}_{1} + 1 ) - △ Pri ( {n}_{1} ) ;$$
$$PrD 2 ( {n}_{2} ) = PrD 1 ( {n}_{2} + 1 ) - PrD 1 ( {n}_{2} ) ;$$
$$PrD 3 ( {n}_{3} ) = PrD 2 ( {n}_{3} + 1 ) - PrD 2 ( {n}_{3} ) ;$$
where n₁ is a serial number and ranges from 1 to D₁-1, and D₁ is a number of pseudorange observations comprised in the data segment; PrD1 (1) to PrD1(D₁-1) form a single difference array PrD1 of pseudorange observations;
n₂ is a serial number and ranges from 1 to D₁-2, and PrD2 (1) to PrD2 (D₁-2) form a double difference array PrD2 of pseudorange observations; and
n₃ is a serial number and ranges from 1 to D₁-3, and PrD3(1) to PrD3(D₁-3) form a triple difference array PrD3 of pseudorange observations;
a single difference CpD1(n₅), a double difference CpD2(n₆), and a triple difference CpD3(n₇) of carrier phase observations are expressed as:
$$CpD 1 ( {n}_{5} ) = △ Cpi ( {n}_{5} + 1 ) - △ Cpi ( {n}_{5} ) ;$$
$$CpD 2 ( {n}_{6} ) = CpD 1 ( {n}_{6} + 1 ) - CpD 1 ( {n}_{6} ) ;$$
$$CpD 3 ( {n}_{7} ) = CpD 2 ( {n}_{7} + 1 ) - CpD 2 ( {n}_{7} ) ;$$
where n₅ is a serial number and ranges from 1 to D₂-1, and D₂ is a number of carrier phase observations comprised in the data segment; CpD1(1) to CpD1(D₂-1) form a single difference array CpD1 of carrier phase observations;
n₆ is a serial number and ranges from 1 to D₂-2, and CpD2(1) to CpD2 (D₂-2) form a double difference array CpD2 of carrier phase observations; and
n₇ is a serial number and ranges from 1 to D₂-3, and CpD3(1) to CpD3 (D₂-3) form a triple difference array CpD3 of carrier phase observations.

5. The method according to claim 4, wherein the pseudorange root mean square X_{RMS} value and the pseudorange standard deviation X_{STD} value in S5 are determined as follows:
$${X}_{RMS} = \frac{1}{A} \cdot \sqrt{\frac{1}{{D}_{1} - 3} ( {\sum }_{{n}_{3} = 1}^{{D}_{1} - 3} {\vert Pr D 3 ( {n}_{3} ) \vert}^{2} )} ,$$
where A is a noise coefficient for the triple difference of observations;
$${X}_{STD} = \frac{1}{A} \cdot \sqrt{\frac{1}{{D}_{1} - 4} ( {\sum }_{{n}_{3} = 1}^{{D}_{1} - 3} {\vert Pr D 3 ( {n}_{3} ) - \overline{{X}_{1}} \vert}^{2} )} ,$$
$$where {\overline{X}}_{1} = \frac{1}{{D}_{1} - 3} {\sum }_{{n}_{3} = 1}^{{D}_{1} - 3} Pr D 3 ( {n}_{3} ) .$$

6. The method according to claim 4, wherein the carrier phase root mean square X_{RMS2} value and the carrier phase standard deviation X_{STD} value in S5 are determined as follows:
$${X}_{RMS 2} = \frac{1}{A} \cdot \sqrt{\frac{1}{{D}_{1} - 3} ( {\sum }_{{n}_{3} = 1}^{{D}_{1} - 3} {\vert Cp D 3 ( {n}_{3} ) \vert}^{2} )} ,$$
$${X}_{STD 2} = \frac{1}{A} \cdot \sqrt{\frac{1}{{D}_{1} - 4} ( {\sum }_{{n}_{3} = 1}^{{D}_{1} - 3} {\vert Cp D 3 ( {n}_{3} ) - \overline{{X}_{2}} \vert}^{2} )} ,$$
$$where {\overline{X}}_{2} = \frac{1}{{D}_{1} - 3} {\sum }_{{n}_{3} = 1}^{{D}_{1} - 3} Cp D 3 ( {n}_{3} ) .$$

7. A method for determining a raw observation accuracy of a spaceborne global navigation satellite system (GNSS) receiver, and the method is applied in a dynamic observation scenario and comprises:
T1: selecting a raw observation data file, and obtaining, by performing data preprocessing, continuous observation data of pseudorange and continuous observation data of carrier phase without consecutive zero values within a threshold range corresponding to each frequency point of each satellite channel;
T2: selecting a frequency point, selecting, among the K channels corresponding to a selected frequency point, one channel as a reference channel and K-1 channels as test channels, filtering, based on a satellite orbit type, pseudorange data and carrier phase data of the reference channel from preprocessed data of the raw observation data file as reference channel data, and filtering, based on the satellite orbit type, pseudorange data and carrier phase data of the K-1 channels from the preprocessed data of the raw observation data file as test channel data;
T3: selecting a test channel, searching for a time intersection between the reference channel data and selected test channel data, and filtering data segments that meet a time length threshold within the time intersection, obtaining a number of data segments, N, and a starting time and an ending time of each data segment;
T4: selecting a data segment, obtaining inter-channel differences between the reference channel data and the test channel data in the selected data segment, and obtaining, by performing a quadruple difference on the inter-channel differences, a quadruple difference array PrD4 of pseudorange observations and a quadruple difference array CpD4 of carrier phase observations;
T5: determining a pseudorange root mean square X_{RMS} value and a pseudorange standard deviation X_{STD} value for the selected data segment of a selected test channel based on the quadruple difference array PrD4 of pseudorange observations, and determining a carrier phase root mean square X_{RMS2} value and a carrier phase standard deviation X_{STD} value for the selected data segment of the selected test channel based on the quadruple difference array CpD4 of carrier phase observations;
T6: repeating steps T4 to T5, obtaining a first set of pseudorange root mean square X_{RMS} values, pseudorange standard deviation X_{STD} values, carrier phase root mean square X_{RMS2} values, and carrier phase standard deviation X_{STD} values for N data segments of the selected test channel, and outputting the first set of pseudorange root mean square X_{RMS} values, the pseudorange standard deviation X_{STD} values, the carrier phase root mean square X_{RMS2} values, and carrier phase standard deviation X_{STD} values graphically;
T7: repeating steps T3 to T6, obtaining a second set of pseudorange root mean square X_{RMS} values, pseudorange standard deviation X_{STD} values, carrier phase root mean square X_{RMS2} values, and the carrier phase standard deviation X_{STD} values of N data segments of all test channels corresponding to the selected frequency point;
T8: repeating steps T2 to T7, obtaining a third set of pseudorange root mean square X_{RMS} values, pseudorange standard deviation X_{STD} values, carrier phase root mean square X_{RMS2} values, and the standard deviation X_{STD} values for N data segments of all test channels corresponding to all frequency points;
T9: repeating steps T1 to T8, obtaining a fourth set of pseudorange root mean square X_{RMS} values, pseudorange standard deviation X_{STD} values, carrier phase root mean square X_{RMS2} values, and carrier phase standard deviation X_{STD} values for N data segments of all test channels corresponding to all frequency points in all raw observation data files, and outputting the fourth set of pseudorange root mean square X_{RMS} values, pseudorange standard deviation X_{STD} values, carrier phase root mean square X_{RMS2} values, and carrier phase standard deviation X_{STD} values as the raw observation accuracy of the spaceborne GNSS receiver; and
adjusting a component of the spaceborne GNSS receiver based on the raw observation accuracy of the spaceborne GNSS receiver when the raw observation accuracy does not meet an accuracy requirement.

8. The method according to claim 7, wherein obtaining the quadruple difference array PrD4 of pseudorange observations and the quadruple difference array CpD4 of carrier phase observations in T4 comprises:
step T41: obtaining the inter-channel differences between the reference channel data and the test channel data in the data segment:
$$Δ {Pr}_{i} = {Pr}_{ij} - {Pr}_{ik}$$
$$Δ {Cp}_{i} = {Cp}_{ij} - {Cp}_{ik}$$
where ΔPrᵢ represents an inter-channel difference array of pseudorange observations obtained in an i-th data segment, ΔCpᵢ represents an inter-channel difference array of carrier phase observations obtained in the i-th data segment, i is a data segment serial number, with a value range from 1 to N; Prᵢⱼ represents an array composed of all pseudorange observations of the reference channel in the i-th data segment, Prᵢₖ represents an array composed of all pseudorange observations of a k-th test channel in the i-th data segment; Cpᵢⱼ represents an array composed of all carrier phase observations of the reference channel in the i-th data segment, Cpᵢₖ represents an array composed of all carrier phase observations of the k-th test channel in the i-th data segment; wherein k=1, 2, . . . , K, and k≠j; and
step T42: performing a quadruple difference on the inter-channel difference array ΔPrᵢ of pseudorange observations and the inter-channel difference array ΔCpᵢ of carrier phase observations respectively;
wherein a single difference PrD1(n₁), a double difference PrD2(n₂), a triple difference PrD3(n₃), and a quadruple difference PrD4(n₄) of pseudorange observations are expressed as:
$$PrD 1 ( {n}_{1} ) = Δ Pri ( {n}_{1} + 1 ) - Δ Pri ( {n}_{1} ) ;$$
$$PrD 2 ( {n}_{2} ) = PrD 1 ( {n}_{2} + 1 ) - PrD 1 ( {n}_{2} ) ;$$
$$PrD 3 ( {n}_{3} ) = PrD 2 ( {n}_{3} + 1 ) - PrD 2 ( {n}_{3} ) ;$$
$$PrD 4 ( {n}_{4} ) = PrD 3 ( {n}_{4} + 1 ) - PrD 3 ( {n}_{4} ) ;$$
where n₁ is a serial number and ranges from 1 to D₁-1, and D₁ is a number of pseudorange observations comprised in the data segment; PrD1(1) to PrD1(D₁-1) form a single difference array PrD1 of pseudorange observations;
n₂ is a serial number and ranges from 1 to D₁-2, and PrD2(1) to PrD2(D₁-2) form a double difference array PrD2 of pseudorange observations;
n₃ is a serial number and ranges from 1 to D₁-3, and PrD3(1) to PrD3(D₁-3) form a triple difference array PrD3 of pseudorange observations; and
n₄ is a serial number and ranges from 1 to D₁-4, and PrD4(1) to PrD4(D₁-4) form a quadruple difference array PrD4 of pseudorange observations;
a single difference CpD1(n₅), a double difference CpD2(n₆), a triple difference CpD3(n₇), and a quadruple difference CpD4 (n₈) of carrier phase observations are expressed as:
$$CpD 1 ( {n}_{5} ) = Δ Cpi ( {n}_{5} + 1 ) - Δ Cpi ( {n}_{5} ) ;$$
$$CpD 2 ( {n}_{6} ) = CpD 1 ( {n}_{6} + 1 ) - CpD 1 ( {n}_{6} ) ;$$
$$CpD 3 ( {n}_{7} ) = CpD 2 ( {n}_{7} + 1 ) - CpD 2 ( {n}_{7} ) ;$$
$$CpD 4 ( {n}_{8} ) = CpD 3 ( {n}_{8} + 1 ) - CpD 3 ( {n}_{8} ) ;$$
where n₅ is a serial number and ranges from 1 to D₂-1, and D₂ is a number of carrier phase observations comprised in the data segment; CpD1(1) to CpD1(D₂-1) form a single difference array CpD1 of carrier phase observations;
no is a serial number and ranges from 1 to D₂-2, and CpD2(1) to CpD2(D₂-2) form a double difference array CpD2 of carrier phase observations;
n₇ is a serial number and ranges from 1 to D₂-3, and CpD3(1) to CpD3(D₂-3) form a triple difference array CpD3 of carrier phase observations; and
ng is a serial number and ranges from 1 to D₂-4, and CpD4 (1) to CpD4(D₂-4) form a quadruple difference array CpD4 of carrier phase observations.

9. The method according to claim 8, wherein the pseudorange root mean square X_{RMS} value and the pseudorange standard deviation X_{STD} value in T4 are determined as follows:
$${X}_{RMS} = \frac{1}{B} \cdot \sqrt{\frac{1}{{D}_{1} - 4} ( {\sum }_{{n}_{3} = 1}^{{D}_{1} - 4} {\vert Pr D 4 ( {n}_{4} ) \vert}^{2} )} ,$$
where B is a noise coefficient for the quadruple difference of observations;
$${X}_{STD} = \frac{1}{B} \cdot \sqrt{\frac{1}{{D}_{1} - 5} ( {\sum }_{{n}_{4} = 1}^{{D}_{1} - 4} {\vert Pr D 4 ( {n}_{4} ) - \overline{{X}_{3}} \vert}^{2} )}$$
$$where \overline{{X}_{3}} = \frac{1}{{D}_{1} - 4} {\sum }_{{n}_{4} = 1}^{{D}_{1} - 4} Pr D 4 ( {n}_{4} ) .$$

10. The method according to claim 8, wherein the carrier phase root mean square X_{RMS2} and the carrier phase standard deviation X_{STD} in T4 are determined as follows:
$${X}_{RMS 2} = \frac{1}{B} \cdot \sqrt{\frac{1}{{D}_{1} - 4} ( {\sum }_{{n}_{3} = 1}^{{D}_{1} - 4} {\vert Cp D 4 ( {n}_{4} ) \vert}^{2} )} ,$$
$${X}_{STD 2} = \frac{1}{B} \cdot \sqrt{\frac{1}{{D}_{1} - 5} ( {\sum }_{{n}_{4} = 1}^{{D}_{1} - 4} {\vert Cp D 4 ( {n}_{4} ) - \overline{{X}_{4}} \vert}^{2} )}$$
$$where \overline{{X}_{4}} = \frac{1}{{D}_{1} - 4} {\sum }_{{n}_{4} = 1}^{{D}_{1} - 4} Cp D 4 ( {n}_{4} ) .$$

11. An electronic device, comprising:
a memory, configured to store computer-readable instructions; and
a processor, configured to run the computer-readable instructions to execute a method for determining a raw observation accuracy of a spaceborne global navigation satellite system (GNSS) receiver, wherein the spaceborne GNSS receiver comprises Y satellite navigation systems, each satellite navigation system comprises M frequency points, and each frequency point corresponds to K channels; where Y≥1, M≥1, K>1; one raw observation data file stores data of M*K channels corresponding to all frequency points of one satellite navigation system; and the method is applied in a static observation scenario and comprises:
S1: selecting a raw observation data file, and obtaining, by performing data preprocessing, continuous observation data of pseudorange and continuous observation data of carrier phase in data of each channel corresponding to each frequency point, wherein the continuous observation data of pseudorange is within a pseudorange threshold range, and the continuous observation data of carrier phase does not comprise consecutive zero values;
S2: selecting a frequency point, selecting, among the K channels corresponding to a selected frequency point, one channel as a reference channel and K-1 channels as test channels, filtering, based on a satellite orbit type, pseudorange data and carrier phase data of the reference channel from preprocessed data of the raw observation data file as reference channel data, and filtering, based on the satellite orbit type, pseudorange data and carrier phase data of the K-1 channels from the preprocessed data of the raw observation data file as test channel data;
S3: selecting a test channel, searching for a time intersection between the reference channel data and selected test channel data, and filtering data segments that meet a time length threshold within the time intersection, obtaining a number of data segments, N, and a starting time and an ending time of each data segment;
S4: selecting a data segment, obtaining inter-channel differences between the reference channel data and the test channel data in the selected data segment, and obtaining, by performing a triple difference on the inter-channel differences, a triple difference array PrD3 of pseudorange observations and a triple difference array CpD3 of carrier phase observations;
S5: determining a pseudorange root mean square X_{RMS} value and a pseudorange standard deviation X_{STD} value for the selected data segment of a selected test channel based on the triple difference array PrD3 of pseudorange observations, and determining a carrier phase root mean square X_{RMS2} value and a carrier phase standard deviation X_{STD2} value for the selected data segment of the selected test channel based on the triple difference array CpD3 of carrier phase observations;
S6: repeating steps S4 to S5, obtaining a first set of pseudorange root mean square X_{RMS} values, pseudorange standard deviation X_{STD} values, carrier phase root mean square X_{RMS2} values, and carrier phase standard deviation X_{STD2} values for N data segments of the selected test channel, and outputting the first set of pseudorange root mean square X_{RMS} values, pseudorange standard deviation X_{STD} values, carrier phase root mean square X_{RMS2} values, and carrier phase standard deviation X_{STD2} values graphically;
S7: repeating steps S3 to S6, obtaining a second set of pseudorange root mean square X_{RMS} values, pseudorange standard deviation X_{STD} values, carrier phase root mean square X_{RMS2} values, and carrier phase standard deviation X_{STD2} values for N data segments of all test channels corresponding to the selected frequency point;
S8: repeating steps S2 to S7, obtaining a third set of pseudorange root mean square X_{RMS} values, pseudorange standard deviation X_{STD} values, carrier phase root mean square X_{RMS2} values, and carrier phase standard deviation X_{STD2} values of N data segments of all test channels corresponding to all frequency points;
S9: repeating steps S1 to S8, obtaining a fourth set of pseudorange root mean square values, pseudorange standard deviation X_{STD} values, carrier phase root mean square X_{RMS2} values, and carrier phase standard deviation X_{STD2} values of N data segments of all test channels corresponding to all frequency points in all raw observation data files, and outputting the fourth set of pseudorange root mean square X_{RMS} values, pseudorange standard deviation X_{STD} values, carrier phase root mean square X_{RMS2} values, and carrier phase standard deviation X_{STD2} values as the raw observation accuracy of the spaceborne GNSS receiver; and
adjusting a component of the spaceborne GNSS receiver based on the raw observation accuracy of the spaceborne GNSS receiver when the raw observation accuracy does not meet an accuracy requirement.

12. (canceled)

13. An electronic device, comprising:
a memory, configured to store computer-readable instructions; and
a processor, configured to run the computer-readable instructions to execute the method according to claim 7.

14. (canceled)

15. The electronic device according to claim 11, wherein performing the data preprocessing in S1 comprises: removing data segments with a specified data length from the raw observation data file, and filtering pseudorange values and carrier phase values in the raw observation data file based on a filtering rule, wherein the filtering rule comprises: setting the pseudorange threshold range based on different orbital altitudes of different navigation satellites, and obtaining pseudorange observation data within the pseudorange threshold range by filtering; and filtering out a data segment where the carrier phase values comprise consecutive zero values in the raw observation data file.

16. The electronic device according to claim 11, wherein a selection rule for the reference channel in S2 comprises: sequentially pre-judging data validity of each channel, and there being valid data and a length of at least one segment of continuous data meeting the time length threshold, wherein the data validity comprises: pseudorange observation data being within the pseudorange threshold range, and carrier phase observation data not comprising consecutive zero values.

17. The electronic device according to claim 11, wherein obtaining the triple difference array PrD3 of pseudorange observations and the triple difference array CpD3 of carrier phase observations in S4 comprises:
step 41: obtaining the inter-channel differences between the reference channel data and the test channel data in the data segment:
$$Δ {Pr}_{i} = {Pr}_{ij} - {Pr}_{ik}$$
$$Δ {Cp}_{i} = {Cp}_{ij} - {Cp}_{ik}$$
where ΔPrᵢ represents an inter-channel difference array of pseudorange observations obtained in an i-th data segment, ΔCpᵢ represents an inter-channel difference array of carrier phase observations obtained in the i-th data segment, i is a data segment serial number, with a value range from 1 to N; Prᵢⱼ represents an array composed of all pseudorange observations of the reference channel in the i-th data segment, Prᵢₖ represents an array composed of all pseudorange observations of a k-th test channel in the i-th data segment; Cpᵢⱼ represents an array composed of all carrier phase observations of the reference channel in the i-th data segment, Cpᵢₖ represents an array composed of all carrier phase observations of the k-th test channel in the i-th data segment; where k=1, 2, . . . , K, and k≠j; and
step 42: performing a triple difference on the inter-channel difference array ΔPrᵢ of pseudorange observations and the inter-channel difference array ΔCpᵢ of carrier phase observations respectively;
wherein a single difference PrD1(n₁), a double difference PrD2(n₂), and a triple difference PrD3(n₃) of pseudorange observations are expressed as:
$$PrD 1 ( {n}_{1} ) = Δ Pri ( {n}_{1} + 1 ) - Δ Pri ( {n}_{1} ) ;$$
$$PrD 2 ( {n}_{2} ) = PrD 1 ( {n}_{2} + 1 ) - PrD 1 ( {n}_{2} ) ;$$
$$PrD 3 ( {n}_{3} ) = PrD 2 ( {n}_{3} + 1 ) - PrD 2 ( {n}_{3} ) ;$$
where n₁ is a serial number and ranges from 1 to D₁-1, and D₁ is a number of pseudorange observations comprised in the data segment; PrD1(1) to PrD1(D₁-1) form a single difference array PrD1 of pseudorange observations;
n₂ is a serial number and ranges from 1 to D₁-2, and PrD2(1) to PrD2(D₁-2) form a double difference array PrD2 of pseudorange observations; and
n₃ is a serial number and ranges from 1 to D₁-3, and PrD3(1) to PrD3(D₁-3) form a triple difference array PrD3 of pseudorange observations;
a single difference CpD1(n₅), a double difference CpD2(n₆), and a triple difference CpD3(n₇) of carrier phase observations are expressed as:
$$CpD 1 ( {n}_{5} ) = Δ Cpi ( {n}_{5} + 1 ) - Δ Cpi ( {n}_{5} ) ;$$
$$CpD 2 ( {n}_{6} ) = CpD 1 ( {n}_{6} + 1 ) - CpD 1 ( {n}_{6} ) ;$$
$$CpD 3 ( {n}_{7} ) = CpD 2 ( {n}_{7} + 1 ) - CpD 2 ( {n}_{7} ) ;$$
where n₅ is a serial number and ranges from 1 to D₂-1, and D₂ is a number of carrier phase observations comprised in the data segment; CpD1(n₅) to CpD1(D₂-1) form a single difference array CpD1 of carrier phase observations;
no is a serial number and ranges from 1 to D₂-2, and CpD2(1) to CpD2(D₂-2) form a double difference array CpD2 of carrier phase observations; and
n₇ is a serial number and ranges from 1 to D₂-3, and CpD3(1) to CpD3(D₂-3) form a triple difference array CpD3 of carrier phase observations.

18. The electronic device according to claim 17, wherein the pseudorange root mean square X_{RMS} value and the pseudorange standard deviation X_{STD} value in S5 are determined as follows:
$${X}_{RMS} = \frac{1}{A} \cdot \sqrt{\frac{1}{{D}_{1} - 3} ( {\sum }_{{n}_{3} = 1}^{{D}_{1} - 3} {\vert Pr D 3 ( {n}_{3} ) \vert}^{2} )} ,$$
where A is a noise coefficient for the triple difference of observations;
$${X}_{STD} = \frac{1}{A} \cdot \sqrt{{\frac{1}{{D}_{1} - 4} ( {\sum }_{{n}_{3} = 1}^{{D}_{1} - 3} \vert Pr D 3 ( {n}_{3} ) - \overline{{X}_{1}} \vert \vert}^{2} )} ,$$
$$where {\overline{X}}_{1} = \frac{1}{{D}_{1} - 3} {\sum }_{{n}_{3} = 1}^{{D}_{1} - 3} Pr D 3 ( {n}_{3} ) .$$

19. The method according to claim 17, wherein the carrier phase root mean square X_{RMS2} value and the carrier phase standard deviation X_{STD2} value in S5 are determined as follows:
$${X}_{RMS 2} = \frac{1}{A} \cdot \sqrt{\frac{1}{{D}_{1} - 3} ( {\sum }_{{n}_{3} = 1}^{{D}_{1} - 3} {\vert Cp D 3 ( {n}_{3} ) \vert}^{2} )} ,$$
$${X}_{STD 2} = \frac{1}{A} \cdot \sqrt{\frac{1}{{D}_{1} - 4} ( {\sum }_{{n}_{3} = 1}^{{D}_{1} - 3} {\vert Cp D 3 ( {n}_{3} ) - \overline{{X}_{2}} \vert}^{2} )} ,$$
$$where {\overline{X}}_{2} = \frac{1}{{D}_{1} - 3} {\sum }_{{n}_{3} = 1}^{{D}_{1} - 3} Cp D 3 ( {n}_{3} ) .$$
